(19) United States
(12) Patent Application Publication
(10) Pub. No.: US 2007/0064040 A1
(43) Pub. Date: Mar. 22, 2007

(54) APPARATUS AND METHOD TO PREVENT PRINTHEAD MALFUNCTION

(76) Inventor: Jung-hwan KIM, Seoul (KR)

Correspondence Address: STANZIONE & KIM, LLP, 919 18TH STREET, N.W., SUITE 440, WASHINGTON, DC, 20006, US

(21) Appl. No.: 11/532,638

(22) Filed: Sep. 18, 2006

(30) Foreign Application Priority Data
Sep. 22, 2005 (KR) 10-2005-0088323

(51) Int. Cl. B41J 29/393

(52) U.S. Cl. 347/19

(57) ABSTRACT

An apparatus and method of preventing a malfunction of a printhead. The method can include sensing a trend of a change of an operation state output singal representing operation state of a heater driver control unit; checking whether the sensed trend is equal to a predetermined trend of a change, which can be an estimated change in case there is an error in controlling heating of a substrate; and solving the error if the sensed trend is equal to the predetermined trend. In the apparatus and method of preventing malfunction in a printhead, heating control signals to control the heating of the nozzles in the printhead are sensed and the sensing result is analyzed to determine whether there is an error. Accordingly, when an error is detected, the printhead is controlled such that a substrate thereof does not overheat and the printhead does not break down. Moreover, when heating of each of the nozzles is controlled, the heating control signals can be sensed and analyzed simultaneously, and thus the interfacing between the printhead and the image forming apparatus can be simplified, as compared to the case when each heating control signal sensed in the printhead-chip is analyzed separately.

### CROSS-REFERENCE TO RELATED APPLICATIONS

This application claims the benefit of Korean Patent Application No. 10-2005-0088323, filed on Sep. 22, 2005, in the Korean Intellectual Property Office, the disclosure of which is incorporated herein in its entirety by reference.

### BACKGROUND OF THE INVENTION

1. Field of the Invention

The present general inventive concept relates to an image forming apparatus, such as a printer, and more particularly, to an apparatus and method to prevent malfunction of a printhead in an image forming apparatus by sensing a heating control signal to control heating of a nozzle formed in the printhead, analyzing the heating control signal and determining whether or not an error exits in the heating control signal and controlling the printhead to operate in accordance with the determination result.

2. Description of the Related Art

A conventional ink ejecting image forming apparatus, such as an inkjet printer, forms an image by using nozzles to eject ink on a printing medium. The nozzles are realized in a head-chip of a printhead.

Ejection of ink is possible only when the temperature of a substrate of the printhead chip is within a predetermined range. Thus, the temperature of the nozzles must be accurately maintained within the predetermined range. Accordingly, precise control of the substrate temperature is essential for accurate image formation.

When an error occurs in controlling the substrate temperature and the substrate overheats, the printhead may melt and cause a fatal defect, a fire, or the like. Therefore, the error must be compensated. However, the conventional image forming apparatus cannot sense such an error.

### SUMMARY OF THE INVENTION

The present general inventive concept provides an apparatus to prevent malfunction of a printhead by sensing an operation state output signal to control heating of a nozzle formed in the printhead, analyzing the sensing result, and solving the error when it is determined that an error exists in controlling to protect the printhead.

The present general inventive concept also provides a method of preventing malfunction of a printhead by sensing heating control signals to control heating of nozzles formed in the printhead, analyzing the sensing result, and solving the error when it is determined that an error exists in controlling to protect the printhead.

The present general inventive concept also provides a computer readable recording medium to store a computer program to execute the above method.

Additional aspects and advantages of the present general inventive concept will be set forth in part in the description which follows and, in part, will be obvious from the description, or may be learned by practice of the general inventive concept.

The foregoing and/or other aspects and utilities of the present general inventive concept are achieved by providing an apparatus to prevent a malfunction of a printhead including: a sensing unit to sense a trend of a change of an operation state output signal representing operation state of a heater driving control unit; a checking unit to check whether the sensed trend is equal to a predetermined trend of a change to estimate that there is an error in controlling heating of a substrate; and an error solving unit to solve the error if the sensed trend is equal to the predetermined trend.

The sensing unit may sense a plurality of the heating control signals to control heating of a plurality of nozzles in each of a plurality of printhead-chips, respectively, formed in a single body in the printhead. Specifically, the sensing unit may sense a wired-ORed result of the plurality of the heating control signals.

The foregoing and/or other aspects and utilities of the present general inventive concept are also achieved by providing a method of preventing a malfunction of a printhead, the method including: sensing a trend of a change of an operation state output singal representing operation state of a heater driver control unit; checking whether the sensed trend is equal to a predetermined trend of a change to estimate that there is an error in controlling heating of a substrate; and solving the error if the sensed trend is equal to the predetermined trend.

The foregoing and/or other aspects and utilities of the present general inventive concept are also achieved by providing a computer readable recording medium to store a computer program performing a method of preventing a malfunction of a printhead, the method including: sensing a change of a heating control signal to control heating of a nozzle in the printhead; checking whether the change of the heating control signal agrees with a predetermined change which may be an estimated change to estimate that there is an error in the control; and solving the error if the change of the heating control signal agrees with the predetermined change.

The foregoing and/or other aspects and utilities of the present general inventive concept are achieved by providing an apparatus to prevent a malfunction of a printhead, including a sensing unit to sense a value associated with each of at least one nozzle of the printhead, a determining unit to determine whether the sensed value for the at least one nozzle corresponds with a predetermined value and an adjusting unit to adjust a characteristic of the at least one nozzle if the determination result determines that the sensed value for the at least one nozzle corresponds with the predetermined value.

The value associated with the at least one nozzle may be a temperature value, and the characteristic of the at least one nozzle adjusted by the adjusting unit is a temperature of a substrate surrounding the nozzle.

The foregoing and/or other aspects and utilities of the present general inventive concept are achieved by providing a method of preventing a malfunction of a printhead, the method including sensing a value associated with a nozzle of the printhead, determining whether the sensed value corresponds with a predetermined value, and adjusting a characteristic of the nozzle if the determination result determines that the sensed value corresponds with the predetermined value.

The value associated with the nozzle may be a temperature value, and the characteristic of the nozzle adjusted by the adjusting unit is a temperature of a substrate surrounding the nozzle.

The foregoing and/or other aspects and utilities of the present general inventive concept are achieved by providing a readable/recordable storage medium to store a program to perform a method of preventing a malfunction of a printhead, the method including sensing a value associated with a nozzle of the printhead, determining whether the sensed value corresponds with a predetermined value and adjusting a characteristic of the nozzle if the determination result determines that the sensed value corresponds with the predetermined value.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a block diagram of an apparatus to prevent a malfunction of a printhead according to an embodiment of the present general inventive concept;

FIG. 2 is a circuit diagram of a heating unit of FIG. 1 according to an embodiment of the present general inventive concept;

FIG. 3 is a block diagram of an apparatus to prevent a malfunction of a printhead having a single printhead-chip according to an embodiment of the present general inventive concept;

FIG. 4 is a block diagram of an apparatus to prevent a malfunction of a printhead having a multi printhead-chip according to an embodiment of the present general inventive concept; and

FIG. 5 is a flowchart of a method of preventing a malfunction of a printhead according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

FIG. 1 is a block diagram of an apparatus to prevent a malfunction of a printhead according to an embodiment of the present general inventive concept.

The apparatus of FIG. 1 can include a heating unit 110, a sensing unit 120, a checking unit 130, and an error solving unit 140.

The heating unit 110 and the error solving unit 140 can be placed in an image forming apparatus. The image forming apparatus may be, for example, an ink-jet printer.

The ink ejecting image forming apparatus includes a printhead, and the printhead includes a printhead-chip. Furthermore, one or more nozzles are formed in the printhead-chip, and examples of such nozzles may include nozzles to eject yellow ink, magenta ink, cyan ink, and black ink.

The heating unit 110 may be formed in the printhead-chip. The temperature of the substrate of the printhead-chip must be maintained within a predetermined range in order to eject ink from the nozzles. When the substrate is heated, the nozzles are heated consequently. Therefore, in order to eject ink at a desired point of time and in a desired amount, heating of the nozzles must be precisely controlled. Herein, heating of a substrate means heating of a substrate surrounding a nozzle.

The heating unit 110 includes a heater to heat the nozzles, a heater driving unit to drive the heater, and a heater driving control unit to control the heater driving unit. The heater, the heater driving unit, and the heater driving control unit are all formed in the printhead-chip.

A signal output by the heater driving control unit to represent operation state of the heater driving control unit is denoted hereinafter as an operation state output signal M1. Consequently, how the substrate is heated can be found out by monitoring the operation state output signal M1.

The sensing unit 120 and the error solving unit 140 can be formed outside of the printhead-chip. The sensing unit 120 senses the operation state output signal M1 for a predetermined period of time, which is set in advance and can vary according to a user's preference. Specifically, the sensing unit 120 senses a trend of a change in the operation state output signal M1.

The checking unit 130 checks whether there is an error in the heating of the substrate. Specifically, the checking unit 130 checks whether the sensed trend(s) of a change in the operation state output signal(s) is equal to a predetermined trend of a change, which can be an estimated change to estimate that there is an error in controlling the heating of the substrate(s). Herein, the trend of a change in the operation state output signal refers to how the operation state output signal has been changed.

If the sensed trend of a change in the operation state output signal does not equal to the predetermined trend, the checking unit 130 can determine that the printhead-chip is currently malfunctioning. The checking unit 130 then instructs the error solving unit 140 to operate. The predetermined value is set in advance and can be modified according to a user's preference.

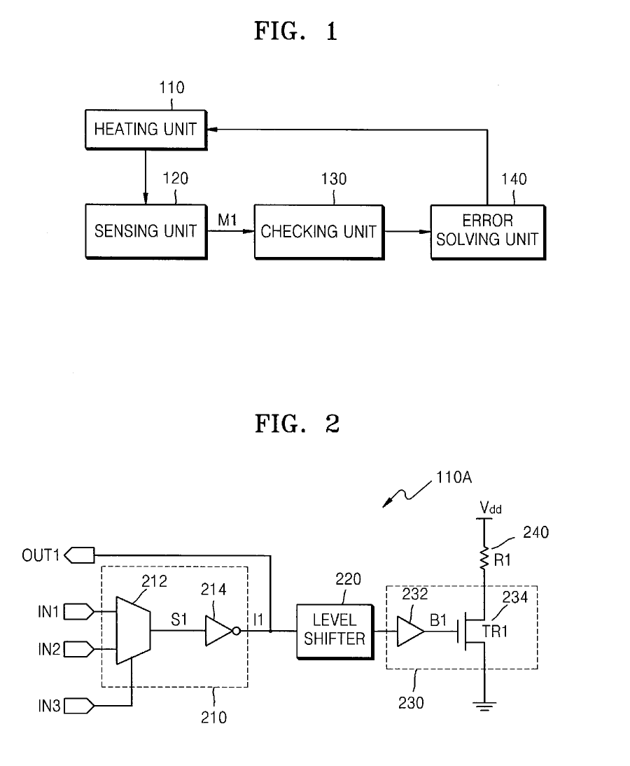

For example, if a heater driving unit 230 (see FIG. 2) operates when the operation state output signal is at a low level, and if the checking unit 130 determines that the accumulated time when the operation state output signal M1 is continuously at a low level is longer than the maximum period of time that the heater can be driven, the checking unit determines that there is an error in controlling the heater driving unit 230 and the printhead-chip is malfunctioning.

The error solving unit 140 operates in response to the determination result of the checking unit 130. For example, the error solving unit 140 can instruct the heating unit 110 not to operate the heater driving unit 230 or set the electric state of the printhead-chip to an initial state.

FIG. 2 is a circuit diagram of the heating unit 110 of FIG. 1 according to an embodiment of the present general inventive concept. The heating unit 110 includes a heater driving control unit 210, a level shifter 220, a heater driving unit 230, and a heater 240. The heater driving control unit 210 includes a selection unit 212 and an inversion unit 214, and the heater driving unit 230 includes a buffer unit 232 and a transistor 234.

“IN 1” indicates the heating control signal M1 generated outside the printhead, and “IN 2” indicates the heating control signal M1 generated in the printhead. “IN 3” is a predetermined selection signal, which can be set in advance and vary according to a user's preference. Herein, the heating control signal is a signal to control the heater driving unit. Moreover, the heating control signal controls the heating of the substrate in the printhead-chip.

A heating control signal “OUT 1” drives the heater driving unit 230 to control the heating of the nozzles, and may be, as illustrated in FIG. 2, a signal S1 which is one of the signals “IN 1” and “IN 2” selected by the selection unit 212 based on the signal “IN 3”. The signal “OUT 1” may be, as illustrated in FIG. 2, the output 11 of the inversion unit 214, which has input S1, or may be the output of the level shifter 220. The signal input to the level shifter 220 may be the signal 11, as illustrated in FIG. 2, or the signal S1, and an output signal of the level shifter 220 is an amplified signal of the signals 11 or S1. Level amplification is performed when the level of the signal “OUT1” does not match the level for output of the heater driving unit 230 to drive the heater 240, even though the logic level of the heating control signal output by the heater driving control unit 210 is the same as the logic level of the heating control signal output by the heater driving unit 230.

The signal (i.e., S1 or 11), whose level is shifted, is then buffered in buffer unit 232, and then output to the transistor TR1 to drive the heater 240. The heater 240 is a resistance R1 in FIG. 2.

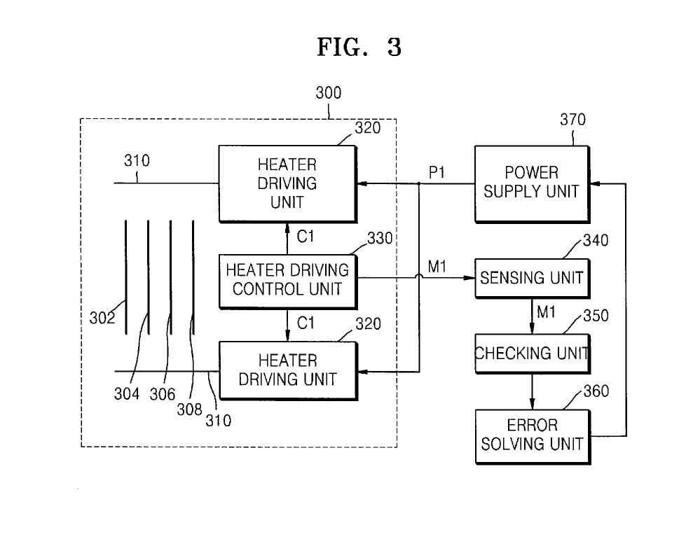

FIG. 3 is a block diagram of an apparatus to prevent a malfunction of a printhead having a single printhead-chip according to an embodiment of the present general inventive concept. The apparatus of FIG. 3 includes a printhead-chip 300, a sensing unit 340, a checking unit 350, an error solving unit 360, and a power supply unit 370.

The printhead-chip 300 includes a heater 310, a heater driving unit 320, and a heater driving control unit 330. Reference numerals 302, 304, 306, and 308 denote respectively a nozzle to eject yellow ink, a nozzle to eject magenta ink, a nozzle to eject cyan ink, and a nozzle to eject black ink.

Descriptions of the heater 310, the heater driving unit 320, and the heater driving control unit 330, the sensing unit 340, the checking unit 350, and the error solving unit 360 will not be given as they respectively correspond to the heater 240, the heater driving unit 230, the heater driving control unit 210, the sensing unit 120, the checking unit 130, and the error solving unit 140 of FIGS. 1 and 2. Also, the power supply unit 370 will not be described as this is well known to one of ordinary skill in the art.

The heater driving control unit 330 outputs a heating control signal C1 to the heater driving unit 320

The heater driving unit 320 drives the heater 310 according to the heating control signal C1 input by the heater driving control unit 330. At this time, it is assumed that the heater driving unit 320 requires a power signal P1 from the power supply unit 370. That is, the heater driving unit 320 does not operate when the power signal P1 is not supplied thereto.

The error solving unit 360 instructs the heater driving unit 320 of the heater 110 not to operate anymore when it is checked and determined by the checking unit 350 that there is an error in controlling the substrate. In this case, the error solving unit 360 instructs the power supply unit 370 not to input power to the heater driving unit 320.

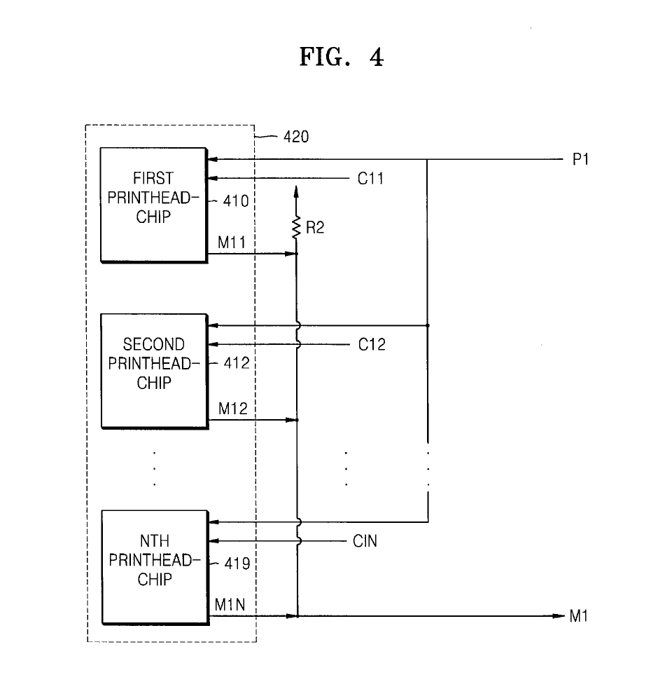

FIG. 4 is a block diagram of an apparatus to prevent a malfunction of a printhead having a multi printhead-chip according to an embodiment of the present general inventive concept. The image forming apparatus has a plurality of printhead-chips 410 through 419, however, the number of printhead chips is not limited by the number as illustrated. In the embodiment of FIG. 4, the printhead-chips 410 through 419 form a multi printhead-chip 420.

The multi printhead-chip 420 can be formed in a single body in the image forming apparatus and can be employed in line type printers forming an image by printing more than one line at a same time.

In FIG. 4, each of the printhead-chips 411 through 419 (or 41N if more printhead-chips) operates in a similar manner as the printhead-chip 300 of FIG. 3.

Operation state output signals can be sensed in each of the printhead-chips, and the operation state output signal M1 input to the checking unit 130 (see FIG. 1) of FIG. 4 may be a wired-ORed result of N operation state output signals M11, M12, . . . , M1N for N respective printhead-chips.

The operation state output signal M11, M12, , , , or M1N may be output by one of an open collector, an open drain, or a tri-state device. R2 indicates a pull-up resistance formed in the open collectors or the open drains when the operation state output signals M11, M12, . . . , M1N are output by the open collectors or open drains.

Similar to FIG. 3, the first printhead-chip 410 may respond to a sensing demand signal C11 to sense the operation state output signal M11, the second printhead-chip 412 may respond to a sensing demand signal C12 to sense a operation state output signal M12, etc.

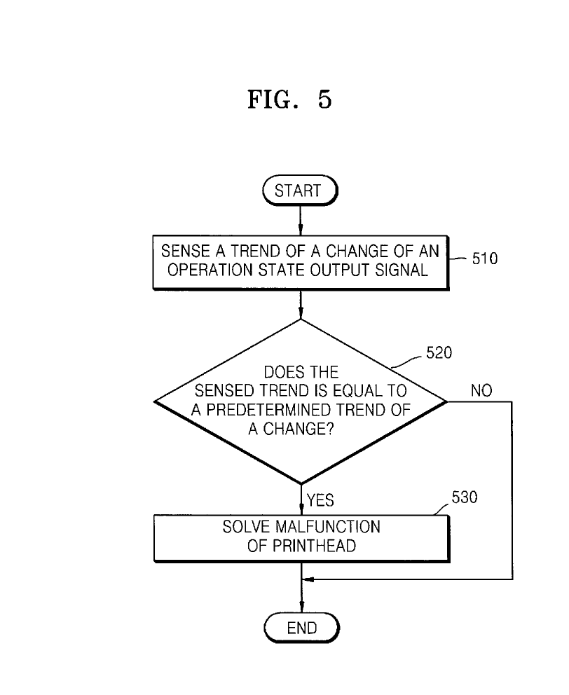

FIG. 5 is a flowchart of a method of preventing a malfunction of a printhead according to an embodiment of the present general inventive concept, which will be described in conjunction with FIG. 1. The method includes operations 510, 520, and 530 of sensing the operation state output signal M1 to control heating of nozzles in a printhead (operation 510), analyzing the result by determining whether a sensed change agrees with a predetermined change (operation 520), and when an error is found, controlling the printhead not to malfunction (operation 530).

In other words, the sensing unit 120 senses the operation state output signal M1 in the printhead to control heating of a nozzle (operation 510). The checking unit 130 checks the change in the operation state output signals sensed by the sensing unit 120 and determines whether the change agrees with a predetermined change which can be an estimated change to estimate that there is an error in the controlling (operation 520).

If the change agrees with the predetermined change, the checking unit 130 can determine that the printhead chip is currently malfunctioning and then instructs the error solving unit 140 to operate. The error solving unit 140 instructs the heating unit 110 to stop the heater driving unit 320 and the heater 240 (operation 530).

The present general inventive concept can also be embodied as computer readable codes on a computer readable recording medium. The computer readable recording medium can be any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the present general inventive concept can be easily construed by programmers skilled in the art to which the present general inventive concept pertains.

As described above, in the apparatus to and method of preventing malfunction of a printhead, operation state output signals in the printhead are sensed, and the sensing result is analysed to determine if there is an error. When an error is found, the printhead is controlled such that a substrate thereof does not overheat and the printhead does not break down. Moreover, when heating of each nozzle is controlled according to the present general inventive concept, the operation state output signals can be sensed and analyzed simultaneously, and thus the interfacing between the printhead and the image forming apparatus can be simplified compared to the case when each of the operation state output signals sensed in the printhead-chip is analysed separately.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An apparatus to prevent a malfunction of a printhead comprising:
a sensing unit to sense a trend of a change of an operation state output signal representing operation state of a heater driving control unit;
a checking unit to check whether the sensed trend is equal to a predetermined trend of a change to estimate that there is an error in controlling heating of a substrate; and
an error solving unit to solve the error if the sensed trend is equal to the predetermined trend.

2. The apparatus of claim 1, wherein the sensing unit senses trends of a change of a plurality of the operation state output signals, respectively, in each of a plurality of printhead-chips, respectively, formed in a single body in the printhead.

3. The apparatus of claim 2, wherein the sensing unit senses a wired-ORed result of the plurality of the operation state output signals.

4. The apparatus of claim 3, wherein the operation state output signal to be wired-ORed is an output of one of an open collector, an open drain, and a tri-state device.

5. The apparatus of claim 1, wherein the error solving unit solves the error by stopping the heating of the substrate.

6. The apparatus of claim 3, wherein the error solving unit solves the error by stopping the heating of any of the substrates in which the respective sensed trend is equal to the predetermined trend.

7. An apparatus to prevent a malfunction of a printhead, comprising:
a sensing unit to sense a value associated with each of at least one nozzle of the printhead;
a determining unit to determine whether the sensed value for the at least one nozzle corresponds with a predetermined value; and
an adjusting unit to adjust a characteristic of the at least one nozzle if the determination result determines that the sensed value for the at least one nozzle corresponds with the predetermined value.

8. The apparatus of claim 7, wherein the value associated with the at least one nozzle is a temperature value, and the characteristic of the at least one nozzle adjusted by the adjusting unit is a temperature of a substrate surrounding the nozzle.

9. The apparatus of claim 7, wherein the adjusting unit adjusts a characteristic of the at least one nozzle by generating a control signal to control adjustment of the characteristic of the nozzle.

10. A method of preventing a malfunction of a printhead, the method comprising:
sensing a trend of a change of an operation state output singal representing operation state of a heater driver control unit; checking whether the sensed trend is equal to a predetermined trend of a change to estimate that there is an error in controlling heating of a substrate; and
solving the error if the sensed trend is equal to the predetermined trend.

11. The method of claim 10, wherein in the operation of sensing a trend of a change of an operation state output signal, trends of a change of a plurality of operation state output signals which are outputted from printhead-chips formed in a single body in the printhead are sensed.

12. The method of claim 11, wherein in the operation of sensing a trend of a change of an operation state output signal, a wired-ORed result of the plurality of operation state output signals is sensed.

13. The method of claim 12, wherein the operation state output signal to be wired-ORed is an output of one of an open collector, an open drain, and a tri-state device.

14. The method of claim 10, wherein in the operation of solving the error, the error is solved by stopping the heating of the substrate.

15. A method of preventing a malfunction of a printhead, the method comprising:
sensing a value associated with a nozzle of the printhead;
determining whether the sensed value corresponds with a predetermined value; and
adjusting a characteristic of the nozzle if the determination result determines that the sensed value corresponds with the predetermined value.

16. The method of claim 15, wherein the value associated with the nozzle is a temperature value, and the characteristic of the nozzle adjusted by the adjusting unit is a temperature of a substrate surrounding the nozzle.

17. A computer readable recording medium to store a computer program performing a method of preventing a malfunction of a printhead, the method comprising:
sensing a trend of a change of an operation state output singal representing operation state of a heater driver control unit;
checking whether the sensed trend is equal to a predetermined trend of a change to estimate that there is an error in controlling heating of a substrate; and
solving the error if the sensed trend is equal to the predetermined trend.

18. A readable/recordable storage medium to store a program to perform a method of preventing a malfunction of a printhead, the method comprising:
sensing a value associated with a nozzle of the printhead;
determining whether the sensed value corresponds with a predetermined value; and
adjusting a characteristic of the nozzle if the determination result determines that the sensed value corresponds with the predetermined value.
